(19) United States
(12) Patent Application Publication
(10) Pub. No.: US 2007/0121877 A1
(43) Pub. Date: May 31, 2007

(54) System for managing the addition of a call waiting party to an existing subscriber call connection

(75) Inventor: Mark Alan McCormick, Naperville, IL (US)

Correspondence Address: PATTON BOGGS, 1660 LINCOLN ST, SUITE 2050, DENVER, CO, 80264, US

(73) Assignee: Lucent Technologies, Inc., Murray Hill, NJ (US)

(21) Appl. No.: 11/267,734

(22) Filed: Nov. 4, 2005

(51) Int. Cl. H04M 3/42

(52) U.S. Cl. 379/215.01

(57) ABSTRACT

The system for adding a call waiting party to an existing call connection operates when an incoming call is directed to one of the parties on the existing call connection. The called party receives an indication of the incoming call and flashes to place the other party on the existing call connection on hold and also to pick up the incoming call. After speaking with the calling party, the called party determines that the calling party should communicate with both the called party and the other party on the existing call connection. The called party then operates their phone by inputting specific digits or a code to activate the system for adding the call waiting party to an existing call connection which responds by maintaining the existing call connection and also adding the calling party to the existing call connection.

### CROSS-REFERENCE TO RELATED APPLICATIONS

This application is related to a U.S. Patent application titled “System For Managing The Transfer Of A Call Waiting Party Into An Existing Subscriber Call Connection To Replace A Subscriber Station On The Existing Call Connection” and filed on the same date as the present application.

### FIELD OF THE INVENTION

This invention relates to communication networks and the management of existing subscriber station call connections with respect to call waiting call parties.

### BACKGROUND OF THE INVENTION

It is a problem in the field of communication networks to enable a subscriber, who is a call waiting party on an existing subscriber station call connection, to be included with the two parties on the existing subscriber station call connection.

Presently, when a party who is on an existing subscriber station call connection has a third party in a call waiting mode, there is no ability to enable the call waiting party to be included with the two parties on the existing subscriber station call connection. The addition of another (third) party into an existing subscriber station call connection can only occur in the present telephone network in the form of one of the two parties on the existing subscriber station call connection initiating Three Way Calling and calling the third party. The Three Way Calling feature adds the third party to the existing subscriber station call connection but cannot respond to a third party calling in to one of the two parties on an existing subscriber station call connection. Therefore, the existing communication network is unable, in an existing subscriber station call connection with a call waiting party, to enable the call waiting party to be included with the two parties on the existing subscriber station call connection.

### BRIEF SUMMARY OF THE INVENTION

The above-described problems are solved and a technical advance achieved by the present System For Managing The Addition Of A Call Waiting Party To An Existing Subscriber Call Connection, herein termed “system for adding a call waiting party to an existing call connection”. This system enables a party on the existing subscriber station call connection who receives an incoming call from a third party to add the calling party to the existing subscriber station call connection.

The system for adding a call waiting party to an existing call connection operates when an incoming call is directed to one of the parties on the existing call connection. The called party receives an indication of the incoming call and flashes to place the other party on the existing call connection on hold and also to pick up the incoming call. After speaking with the calling party, the called party determines that the calling party should communicate with both the called party and the other party on the existing call connection. The called party then operates their phone by inputting specific digits or a code to activate the system for adding the call waiting party to an existing call connection which responds by maintaining the existing call connection and also adding the calling party to the existing call connection. All three parties are then on the call connection and continue to converse until one of the three parties disconnects from the call, creating the billing record and releasing the call resources.

The call remains up until either party disconnects. There is also the possibility of another incoming call (call waiting) that is desired to be added or not. This also allows for normal Three Way Calling to occur after the disconnecting of one of the parties.

If the called party hangs up, then it would be subject to any consequence of a Three Way Call. In this case, the two other parties would be dropped or the call could be “transferred” to the other two parties.

### BRIEF DESCRIPTION OF THE DRAWINGS

FIG. 1 illustrates, in block diagram form, the overall architecture of a telephone network and a typical call connection that uses the present system for adding a call waiting party to an existing call connection; and

FIG. 2 illustrates, in flow diagram form the operational steps taken by the present system for adding a call waiting party to an existing call connection to implement a call transfer for a subscriber station.

### DETAILED DESCRIPTION OF THE INVENTION

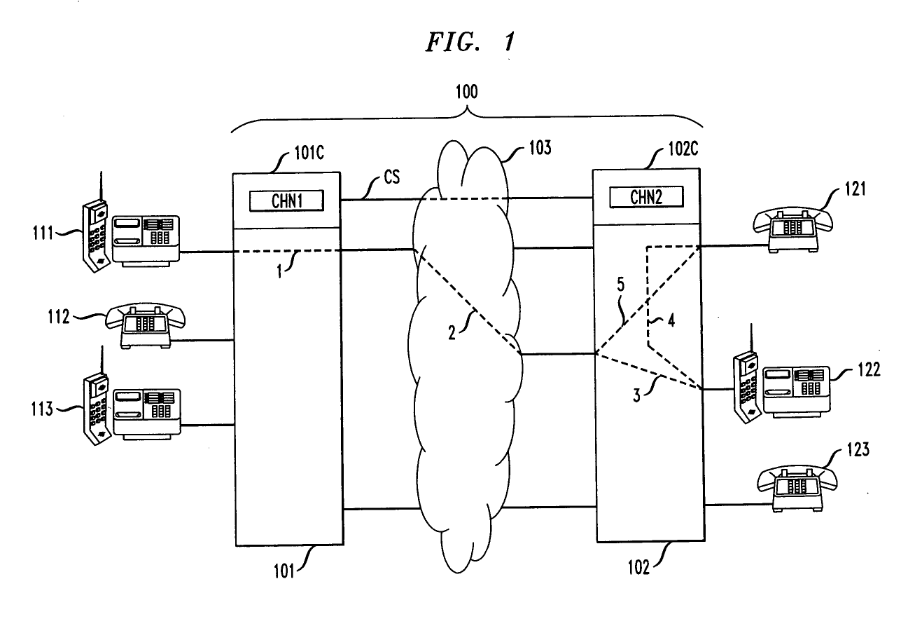

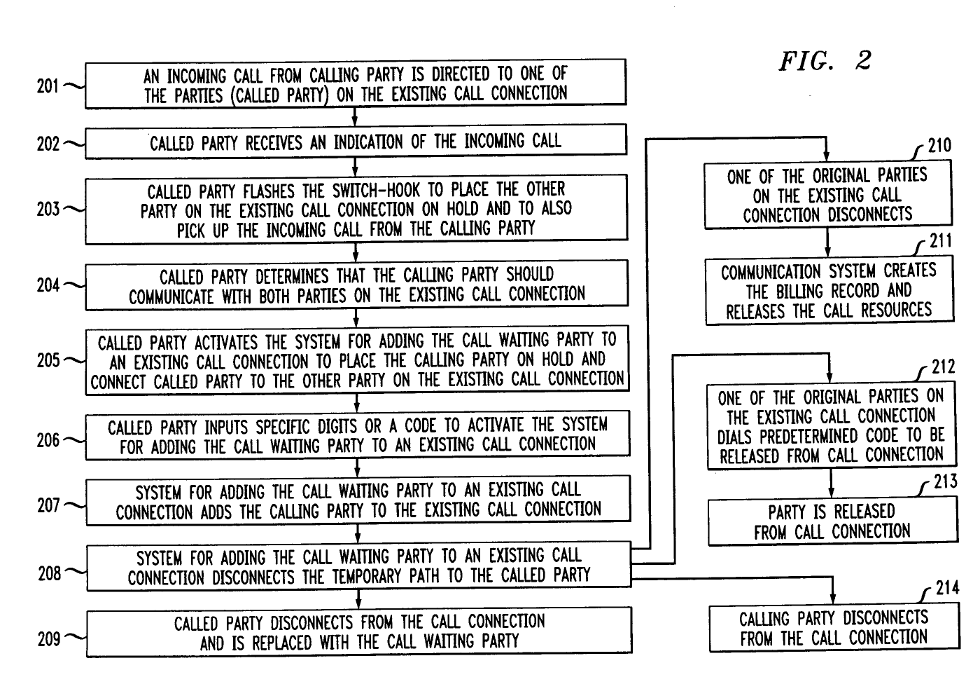

FIG. 1 illustrates, in block diagram form, the overall architecture of a telephone network and a typical call connection that uses the present system for adding a call waiting party to an existing call connection; and FIG. 2 illustrates, in flow diagram form, the operational steps taken by the present system for adding a call waiting party to an existing call connection to implement a call transfer for a subscriber station.

The communications network comprises a traditional voice communications network that includes a plurality of local communications systems. This could be a PSTN land configuration, wireless configuration, or a combination of the two 101C, 102C, such as telephone switching systems that are part of the Public Switched Telephone Network (PSTN) 100 and are interconnected via trunk circuits (this could be an IP connection as well) to an Inter-Exchange Carrier System (IXC) 103. Each of the communications systems 101, 102 serve a plurality of terminal devices, and the communications systems 101, 102 maybe interconnected via an out-of-band signaling link CS through the Inter-Exchange Carrier System (IXC) 103, using the well-known SS7 signaling protocol This could also be using the IP protocol as well. The operation of such a communications network is well known and is not described in detail herein. The communications systems 101, 102 provide a set of features and services to the terminal devices that they serve, including a system for adding a call waiting party to an existing call connection wherein the communications systems 101, 102 implement the call connection function for the associated terminal devices in response to control signals that are received from the terminal devices. In addition, the communications systems 101, 102 are both equipped with the system for transferring a call connection to a call waiting party CHN1, CHN2 that are operational in the controllers 101C 102C of the respective communications systems 101, 102.

For the purpose of illustration, the call connection used to describe the operation of the present system for transferring a call connection to a call waiting party CHN2 consists of terminal device 111 connected to terminal device 122. The connection extends from terminal device 111 through communication system 101 (path 1), Inter-Exchange Carrier System (XC) 103 (path 2), communication system 102 (path 3), to terminal device 122. The use of multiple communication systems and the Inter-Exchange Carrier System (IXC) for the call connection is not a limitation on the operation of the system for transferring a call connection to a call waiting party CHN2, since the call connection can be solely within communication system 102, or may include one or more mobile terminal devices and their associated Mobile Switching Centers (not shown).

In this environment, the only way to add a third party to the existing call connection or to substitute a third party for one of the two parties on the existing call connection is to use the Three Way Calling feature. The Three Way Calling feature is initiated when one of the two parties (first party on the existing call connection flashes the switch hook to place the other party on hold and initiates a call to the third party. The third party is then connected to the first party, who can again flash the switch-hook to add the third party to the existing call connection. Unfortunately, this feature is only outbound capable, in that one of the two parties on the existing call connection is the only one who can contact the third party.

The system for transferring a call connection to a call waiting party CHN2 operates to enable a third party (calling part to contact one party on an existing call connection and be added to the existing call connection. This process is initiated when an incoming call from calling party located at terminal device 121 is directed to the terminal device 122 of one of the parties on the existing call connection (paths 1-3) at step 201. The called party receives an indication of the incoming call on their terminal device 122 at step 202 and flashes the switch hook of their terminal device 122 at step 203 to place the terminal device 111 of the other party on the existing call connection on hold and also to pick up the incoming call from the calling party by connecting the terminal device 121 of the calling party to the terminal device 122 of the called party over path 4. After speaking with the calling party, the called party at step 204 determines that the calling party should communicate with both the called party and the other party on the existing call connection. The called party then operates their terminal device 122 at step 205 by inputting specific digits or a code to activate the system for adding the call waiting party to an existing call connection CHN2, which responds by maintaining paths 1-3 of the existing call connection while adding the terminal device 121 of the calling party to the existing call connection via path 5 at step 206 and dropping path 4 at step 207.

All three parties are then on the call connection and continue to converse until one of the three parties disconnects from the call at step 208, creating the billing record and releasing the call resources at step 209.

### SUMMARY

The system for adding a call waiting party to an existing call connection enables a party on the existing subscriber station call connection who receives an incoming call from a third party to add the calling party to the existing subscriber station call connection.

What is claimed as new and desired to be protected by Letters Patent of the United States is:

1. A system for adding a call waiting party to an existing call connection between a first patty located at a first subscriber station and a second party located at a second subscriber station, comprising:
incoming call processing means, responsive to an incoming call directed to a one of a first party and a second party engaged in an existing subscriber call connection, for generating an alert indication at the one of said first subscriber station and said second subscriber station associated with said one of a first party and a second party; and
calling party addition means, responsive to said one of said first party and said second party inputting a predetermined code into the respective one of said first subscriber station and said second subscriber station, for adding said incoming call to said existing call connection.

2. The system for adding a call waiting party to an existing call connection of claim 1, further comprising:
disconnect means, responsive to said one of said first party and said second party disconnecting from said existing call connection, for releasing said call connection.

3. The system for adding a call waiting party to an existing call connection of claim 1, further comprising:
call hold means, responsive to said one of a first party and a second party flashing their associated subscriber station in response to receipt of said alert indication, for placing the other of said first party and a second party on hold.

4. The system for adding a call waiting party to an existing call connection of claim 3, further comprising: calling party means, responsive to said one of a first party and a second party flashing their associated subscriber station in response to receipt of said alert indication, for connecting said calling party with said one of said first party and a second party.

5. The method of adding a call waiting party to an existing call connection between a first party located at a first subscriber station and a second party located at a second subscriber station, comprising:
generating, in response to an incoming call directed to a one of a first party and a second party engaged in an existing subscriber call connection, an alert indication at the one of said first subscriber station and said second subscriber station associated with said one of a first party and a second party; and
adding, in response to said one of said first party and said second party inputting a predetermined code into the respective one of said first subscriber station and said second subscriber station, said incoming call to said existing call connection.

6. The method of adding a call waiting party to an existing call connection of claim 5, further comprising:
releasing, in response to said one of said first party and said second party disconnecting from said existing call connection, said call connection.

7. The method of adding a call waiting party to an existing call connection of claim 5, further comprising:
placing, in response to said one of a first party and a second party flashing their associated subscriber station in response to receipt of said alert indication, the other of said first party and a second party on hold.

8. The method of adding a call waiting party to an existing call connection of claim 7, further comprising:
connecting, in response to said one of a first party and a second party flashing their associated subscriber station in response to receipt of said alert indication, said calling party with said one of said first party and a second party.
